(19) United States
(12) Patent Application Publication
(10) Pub. No.: US 2007/0275706 A1
(43) Pub. Date: Nov. 29, 2007

(54) Communication terminal device

(75) Inventor: Yoshio Furuichi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Minako-ku (JP)

(21) Appl. No.: 11/495,536

(22) Filed: Jul. 31, 2006

(30) Foreign Application Priority Data
May 25, 2006 (JP) 2006-145787

(51) Int. Cl. H04Q 7/22

(52) U.S. Cl. 455/414.2

(57) ABSTRACT

According to an embodiment of the invention, a communication terminal device comprises: a communication unit configured to communicate with a mobile communication terminal device through a network; a memory configured to store a first data representing a position of the communication terminal device; a distance calculation unit configured to calculate a distance from the mobile communication terminal device from a second data representing a position of the mobile communication terminal device received by the communication unit and the first data; a display unit configured to display the calculated distance; and a control unit configured to control the communication unit based on the calculated distance and a predetermined threshold value.

### BACKGROUND

1. Technical Field

The present invention relates to a communication terminal device, and more particularly, to a communication terminal device capable of communicating with a mobile communication terminal device over a network.

2. Description of Related Art

A technology for providing positioning means such as a global positioning system (GPS) receiver in a communication terminal device such as a mobile telephone to control a communication function using a position condition has been known (for example, see Patent Documents 1 to 3).

According to a technology disclosed in JP-A-2001-224064 (pages 2, 6 and 7 and FIG. 2), a mobile terminal having a GPS receiver measures its position, calculates a distance between its position and the position of a reference point which is previously stored, allows call using the mobile terminal when the calculated distance is equal to or smaller than a threshold value, and does not allow the call when the calculated distance is larger than the threshold value.

According to a technology disclosed in JP-A-2002-191075 (pages 2, 5 and 6 and FIG. 1), a mobile terminal having positioning means transmits its position to an opposite terminal. Since the opposite terminal has information on use permission area of the mobile terminal, communication between the mobile terminal and the opposite terminal starts when it is determined that the mobile terminal is in the use permission area.

According to a technology disclosed in JP-2004-56333 (pages 2 to 7 and FIG. 5), a wireless device which belongs to an ad-hoc network and has positioning means measures its position, receives position information of another device, checks whether communication is possible by a predetermined method, and compares a distance between the wireless device and the another device with a threshold value, and determines whether the communication is possible.

### SUMMARY

A communication terminal device having a data communication function can receive data on the position of an opposite party transmitted from an opposite communication terminal device (mobile communication terminal device) connected over a network and calculate a distance from the opposite party when the communication terminal device holds the data on its position. The calculation of the distance from the opposite party can be performed even when the opposite party is located in the distance as far as the communication terminal device and the opposite communication terminal device are covered by a network.

Meanwhile, necessity of communication including the speech with the opposite party may depend on the distance from the opposite party. For example, in a case where detailed guidance of the road is made after the opposite party arrives at the vicinity of a rendezvous, the communication including the speech is needed. In a case where the movement of the opposite party is not finished at the vicinity of the rendezvous even when an expected time elapses and a situation need be confirmed by the communication including the speech, the communication including the speech is needed.

In the technology disclosed in JP-A-2001-224064 (pages 2, 6 and 7 and FIG. 2), it is determined whether the call using the mobile terminal is originated or not, in accordance with the distance between the mobile terminal and the predetermined reference point. The position of the reference terminal is a fixed value which is previously set by a user and stored in the mobile terminal. Accordingly, when it is desired to determine the necessity of the communication in accordance with the distance from the opposite party, the technology disclosed in JP-A-2001-224064 cannot be used.

In the technology disclosed in JP-A-2002-191075 (pages 2, 5 and 6 and FIG. 1), it is determined whether the communication between the mobile terminal and the opposite terminal is possible, depending on the mobile terminal is in the user permission area. The data representing the user permission area is a fixed value which is previously stored in the opposite terminal. Accordingly, when it is desired to determine the necessity of the communication in accordance with the distance from the opposite party, the technology disclosed in JP-A-2001-224064 cannot be used.

In the technology disclosed in JP-2004-56333 (pages 2 to 7 and FIG. 5), it is determined whether the direct communication between the wireless devices (without using a third wireless device) is possible, in accordance with the distance between the wireless devices belonging to the ad-hoc network. Accordingly, the technology disclosed in JP-2004-56333 cannot apply to a communication terminal device belonging to the network including a cellular mobile communication network (mobile communication terminals are connected to the network through a fixed base station).

The present invention is made in view of the above-described problems. According to an aspect of the invention, a communication terminal device can determine necessity of communication in accordance with a distance from a mobile communication terminal device.

According to another aspect of the invention, a communication terminal device comprises: a communication unit configured to communicate with a mobile communication terminal device through a network; a memory configured to store a first data representing a position of the communication terminal device; a distance calculation unit configured to calculate a distance from the mobile communication terminal device from a second data representing a position of the mobile communication terminal device received by the communication unit and the first data; a display unit configured to display the calculated distance; and a control unit configured to control the communication unit based on the calculated distance and a predetermined threshold value.

### BRIEF DESCRIPTION OF THE DRAWINGS

FIG. 1 is an exemplary block diagram of a communication terminal device according to a first embodiment of the present invention.

FIG. 2 is an exemplary view showing the appearance of the communication terminal device according to the first embodiment.

FIG. 3 is an exemplary flowchart showing the operation of the communication terminal device according to the first embodiment.

FIG. 4 is an exemplary view showing an example of the display of a calculated distance in the communication terminal device according to the first embodiment.

FIG. 5 is an exemplary view showing a map display in the communication terminal device according to the first embodiment.

FIG. 6 is an exemplary flowchart showing a first modified example of the operation of the communication terminal device according to the first embodiment.

FIG. 7 is an exemplary flowchart showing a second modified example of the operation of the communication terminal device according to the first embodiment.

FIG. 8 is an exemplary view showing another example of the calculated distance in the communication terminal device according to the first embodiment.

FIG. 9 is an exemplary flowchart showing a third modified example of the operation of the communication terminal device according to the first embodiment.

FIG. 10 is an exemplary block diagram of a communication terminal device according to a second embodiment of the present invention.

### DESCRIPTION OF THE EMBODIMENTS

Hereinafter, embodiments of the present invention will be described with reference to the accompanying drawings.

### First Embodiment

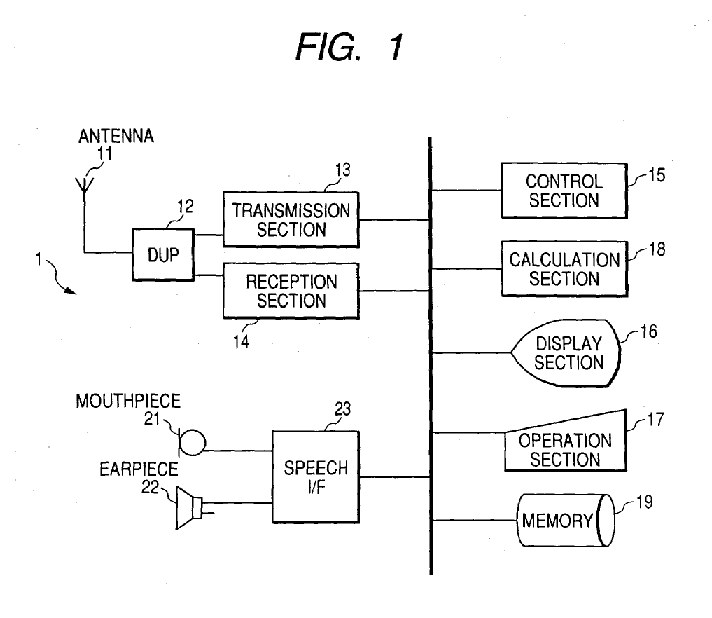

Hereinafter, a first embodiment of the present invention will be described with reference to FIGS. 1 to 9. Although the communication terminal device 1 is a folder type mobile telephone, the other mobile telephone, a personal digital assistant (PDA), a personal computer (PC) or the like may be used, instead of the folder type mobile telephone.

The communication terminal device 1 has an antenna 11. The antenna 11 is connected to a transmission section 13 and a reception section 14 through a transmission/reception switch section 12. The transmission section 13 and the reception section 14 are connected to a control section 15. The control section 15, for example, includes a process device such as a microprocessor or a digital signal processor (DSP). The control section 15 monitors and controls all or a portion of the sections of the communication terminal device 1.

The transmission section 13 modulates a continuous wave by a digital transmission signal obtained by encoding information obtained from the control section 15, frequency-converts and amplifies the modulated output, and generates a wireless transmission wave. The wireless transmission wave is radiated from the antenna 11 through the transmission/reception switch section 12 and is transmitted to a base station (not shown) of a network to which the communication terminal device 1 belongs.

A wireless reception wave which is transmitted from the base station (not shown) to the communication terminal device 1 is received by the reception section 14 through the antenna 11 and the transmission/reception switch section 12. The reception section 14 amplifies and frequency-converts the wireless reception wave and demodulates a digital reception signal carried by the wireless reception wave. The reception section 14 decodes the demodulated output, extracts information transmitted from the base station, and sends the information to the control section 15.

The communication terminal device 1, for example, has a display section 16 including a liquid crystal device. The display section 16 can display a screen including a string, a cursor or an image. The communication terminal device 1 has an operation section 17 including a cross-shaped key, a plurality of character keys, and a plurality of function keys. The cross-shaped key is used to move the cursor on the screen displayed on the display section 16. The character keys are used to input an alphanumeric character or a symbol by a toggle method. The function keys are used to perform functions displayed on the display section 16.

The communication terminal device 1 has a calculation section 18. The calculation section 18 includes the same process device as the control section 15 or a process device different from that of the control section 15. As described below, the calculation section 18 can calculate a distance between the communication terminal device 1 and a different communication terminal device (a mobile communication terminal device).

The communication terminal device 1 has a memory 19. The memory 19 can store data representing the position of the communication terminal device 1 and telephone directory data and map data displayed on the display section 16. The data representing the position of the communication terminal device 1 is, for example, input by the operation of the operation section 17 and stored in the memory 19. The data representing the position of the communication terminal device 1 may be, for example, extracted from the digital reception signal and stored in the memory 19, as described above. The communication terminal device 1 may have a reading device for an external storage medium (not shown) and read the data representing the position of the communication terminal device 1 from the external storage medium (not shown).

The communication terminal device 1 has a mouthpiece 21, an earpiece 22 and a speech interface 23. When communication including speech starts, the speech input from the mouthpiece 21 is converted and encoded into a digital signal by the speech interface 23 and is carried and transmitted by the wireless transmission wave generated in the transmission section 13, as described above. The digital speech signal, which is carried by the wireless reception wave, received and demodulated by the reception section 14, is decoded by the speech interface 23, is converted into an analog speech signal, and is reproduced through the earpiece 22. The communication terminal device 1 may include a camera (not shown) or the like in addition to the above-described components and their description will be omitted.

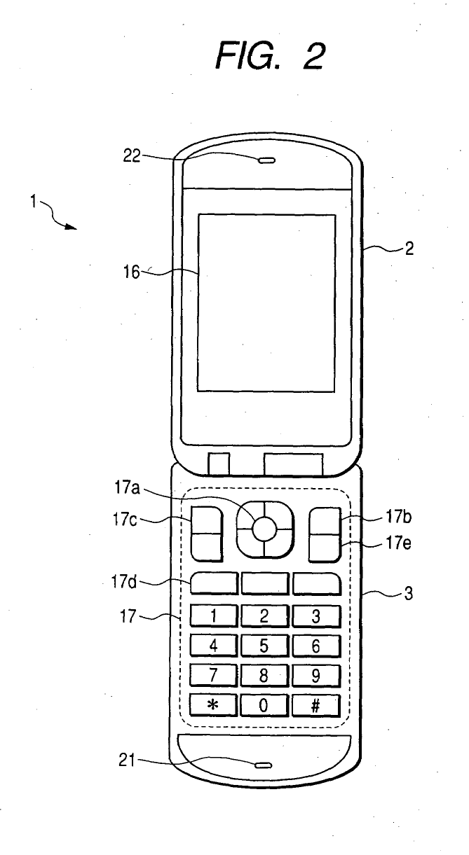

The communication terminal device 1 is a folder type mobile telephone including an upper casing 2 and a lower casing 3 which are openably connected to each other. FIG. 2 is an exemplary view showing the front surface (corresponding to the upper side of the drawing) in a state that the upper casing 2 and the lower casing 3 are opened. The display section 16 and the earpiece 22 are attached on the front surface of the upper casing 2. The operation section 17 and the mouthpiece 21 are attached on the front surface of the lower casing 3.

As described above, the operation section 17 includes the cross-shaped key, the plurality of character keys and the plurality of function keys, which are denoted by a dotted line of FIG. 2. The operation section 17 includes function keys 17a to 17e shown in FIG. 2. The function key 17d is used as a call button.

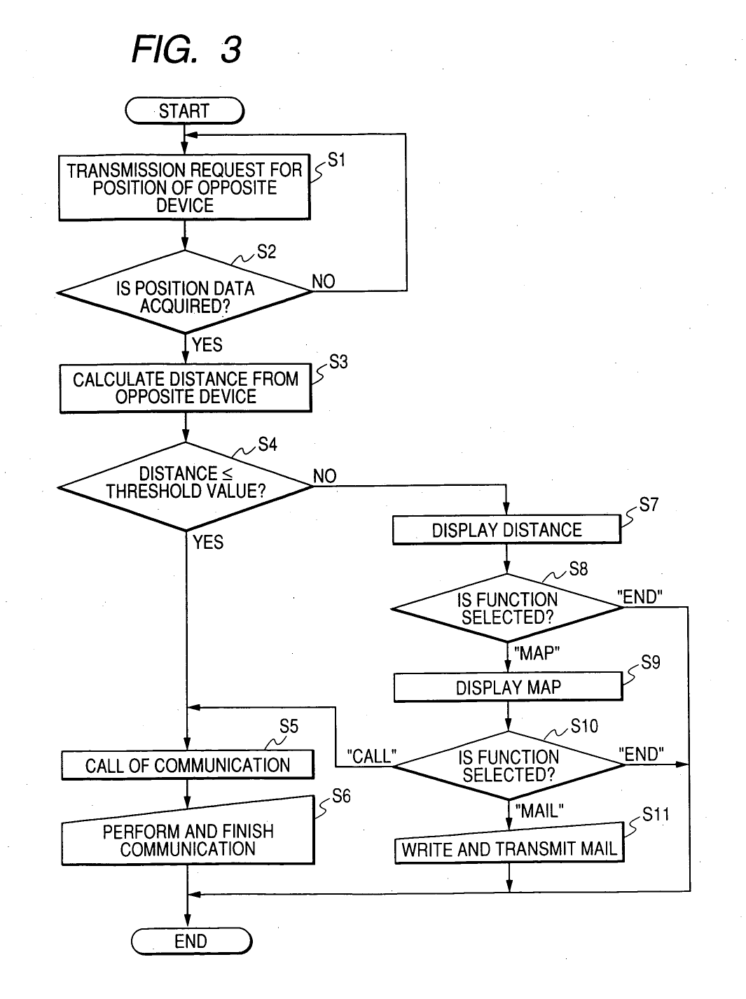

The operation of the communication terminal device 1 will be described with reference to FIG. 3. In the following description, it is assumed that a communication terminal device (for example, a mobile telephone; hereinafter, referred to as an opposite device (mobile communication terminal device)) moves toward the position of the communication terminal device 1. FIG. 3 is a flowchart showing the operation of the communication terminal device 1. It is assumed that the data representing the position of the communication terminal device 1, the map data displayed on the display section 16 and the telephone directory data including the telephone number of the opposite device are stored in the memory 19. It is assumed that the opposite device is previously specified with reference to the telephone directory stored in the memory 19, by the screen display of the display section 16 and the operation of the operation section 17.

The general operation for the call of the speech communication of the communication terminal device 1 is, for example, performed by inputting the telephone number of the opposite device using numeric keys of the operation section 17 and pressing the function key 17d (call button) for a short time (referred to as short pressing). Alternatively, the operation for the call of the speech communication is performed by displaying the telephone directory data stored in the memory 19 on the display section 16, selecting the telephone number of the opposite device using the cross-shaped key of the operation section 17, and pressing the function key 17d for a short time.

The operation for the call of the speech communication, for example, performed by inputting the telephone number of the opposite device using the numeric keys of the operation key 17 and pressing the function key 17d for at least a predetermined time (referred to as long pressing). Alternatively, after the telephone number is input, the short pressing of the function key 17d may be repeated twice. Alternatively, after the telephone number is input, the key (for example, the function key 17e) other than the function key 17d may be pressed. Alternatively, after the telephone number is input, the key (for example, the function key 17e) other than the function key 17d and the function key 17d may be sequentially pressed.

The operation for the call of the speech communication is, for example, performed by displaying the telephone directory data stored in the memory 19 on the display section 16, selecting the telephone number of the opposite device using the cross-shaped key of the operation key 17, and pressing the function key 17d for a long time. Alternatively, after the telephone number is selected, the short pressing of the function key 17d may be repeated twice. Alternatively, after the telephone number is selected, the key (for example, the function key 17e) other than the function key 17d may be pressed. Alternatively, after the telephone number is selected, the key (for example, the function key 17e) other than the function key 17d and the function key 17d may be sequentially pressed. When a process starts by any one of the operations for the call of the speech communication (“START”), the control section 15 sends a transmission request for data representing the position of the opposite device to the transmission section 13 (step S1). As described above, the transmission section 13 generates the wireless transmission wave for carrying the transmission request and radiates the wireless transmission wave using the antenna 11 through the transmission/reception switch section 12. The transmission request carried by the wireless transmission wave is transmitted to the above-described base station and is received by the opposite device over the above-described network.

When the opposite device responds to the transmission request, the data representing the position of the opposite device is transmitted to the communication terminal device 1. The data representing the position of the opposite device is transmitted to the above-described base station over the above-described network. The communication terminal device 1 receives the wireless reception wave for carrying the data representing the position of the opposite device from the above-described base station. As described above, the reception section 14 receives the wireless reception wave through the antenna 11 and the transmission/reception switch section 12, extracts the data representing the position of the opposite device, and transmits the data to the control section 15 (“YES” in the step S2). When the data representing the position of the opposite device is not obtained (for example, during a predetermined time), the control section 15 transmits the transmission request for the data representing the position of the opposite device again (“NO” in the step S2).

The control section 15 sends the data representing the position of the opposite device to the calculation section 18. The calculation section 18 reads the data representing the position of the communication terminal device 1 from the memory 19. The calculation section 18 calculates a distance between the opposite device and the communication terminal device 1 from the data representing the position of the opposite device and the data representing the position of the communication terminal device 1 (step S3).

The calculation section 18 sends the calculated distance between the opposite device and the communication terminal device 1 to the control section 15. The control section 15 compares the calculated distance with a threshold value. When the calculated distance is equal to or smaller than the threshold value (“YES” in the step S4), the control section 15 reads the telephone number of the opposite device from the memory 19 and instructs the transmission section 13 and the reception section 14 to originate the call of the communication including the speech with the opposite device (step S5). Subsequently, the communication using the mouthpiece 21 and the earpiece 22 is performed and finished (step S6) and the control section 15 then finishes the process (“END”). In the case where the communication including the speech starts when the calculated distance is equal to or smaller than the threshold value, for example, the detailed guidance of the road can be made by the communication including the speech after the opposite party arrives at the vicinity of the rendezvous.

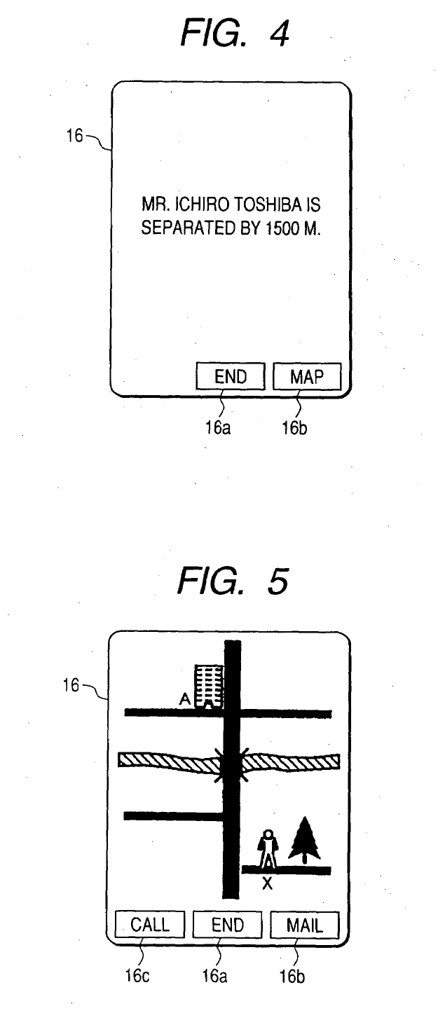

When the calculated distance is larger than the threshold value (“NO” in the step S4), the control section 15, for example, displays the calculated distance on the display section 16, as shown in FIG. 4 (step S7). FIG. 4 is a view showing an example of the display of the calculated distance. In the vicinity of the central portion of the screen of the display section 16 shown in FIG. 4, the name of the person who possesses the opposite device specified with reference to the telephone directory stored in the memory 19 and the calculated distance are displayed. A function display 16a (“END”) and a function display 16b (“MAP”) are displayed on the lower side of the screen of the display section 16 shown in FIG. 4.

When the function key 17a which is included in the operation section 17 and disposed in correspondence with the function display 16a is pressed (“END” in the step S8), the control section 15 determines that the distance from the opposite device is confirmed and finishes the process (“END”).

When the function key 17b which is included in the operation section 17 and disposed in correspondence with the function display 16b is pressed (“MAP” in the step S8), the control section 15 reads the map data in a range including the positions of the communication terminal device 1 and the opposite device from the memory 19 and displays the map data on the display section 16 (step S9).

Also, the map data may be displayed on the display section 16 (step s9), in case that an operation in step S8 is not performed when a predetermined time has passed after step S7 is executed.

FIG. 5 is a view showing an example of the map display. As shown in FIG. 5, in the display section 16, a symbol “A” representing the communication terminal device 1 and a symbol “X” representing the opposite device are displayed on the map. On the lower side of the screen of the display section 16 shown in FIG. 5, the function display 16a (“END”), the function display 16b (“MAIL”) and a function display 16c (“CALL”) are displayed.

When the function key 17a is pressed in the display of FIG. 5 (“END” in the step S10), the control section 15 determines that the position of the opposite device is confirmed on the map and finishes the process (“END”). When the function key 17b is pressed in the display of FIG. 5 (“MAIL” in the step S10), the control section 15 allows an electronic mail to be written by the display section 16, the operation section 17 and so on, allows the written electronic mail to be transmitted to the opposite device through the transmission section 13, the base station and so on (step “S11”), and finishes the process after transmitting the electronic mail (“END”).

When the function key 17c which is included in the operation section 17 and disposed in correspondence with the function display 16c is pressed in the display of FIG. 5 (“CALL” in the step S10), the control section 15 allows the call of the communication including the speech with the opposite device to be originated (step S5).

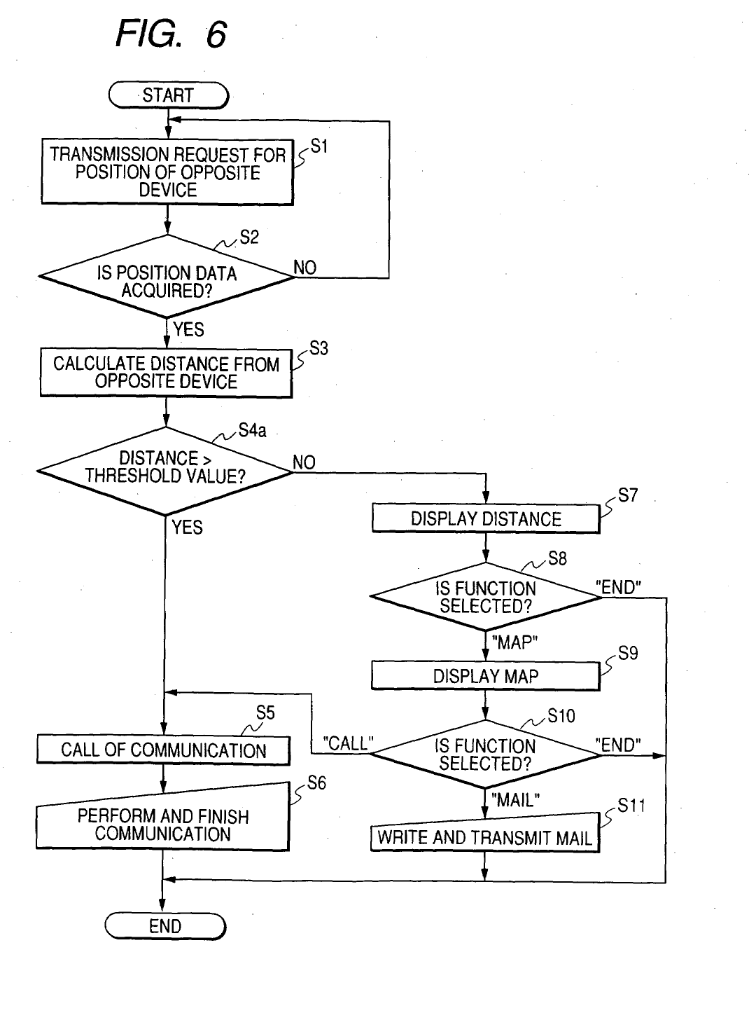

FIG. 6 is a flowchart showing a first modified example of the operation of the communication terminal device 1 according to the first embodiment. Since the flow from the start (“START”) of the process to the step S3 is equal to that of FIG. 3, these steps are denoted by the same reference numerals. The control section 15 instructs the transmission section 13 and the reception section 14 to originate the call of the communication including the speech with the opposite device when the calculated distance between the opposite device and the communication terminal device 1 is larger than the threshold value (“YES” in the step S4a) and, for example, displays the calculated distance on the display section 16 when the calculated distance is equal to or smaller than the threshold value (“NO” in the step S4a), as shown in FIG. 4. Also, the map data may be displayed on the display section 16 (step s9), in case that an operation in step S8 is not performed when a predetermined time has passed after step S7 is executed.

Since the flow until the end (“END”) of the process after the step S4a is equal to that of FIG. 3 except that the branching of the step S4a is opposite to that of the step S4 of FIG. 3, these steps are denoted by the same reference numerals. According to the first modified example, since the communication including the speech starts when the calculated distance is larger than the threshold value, the situation can be confirmed by the communication including the speech when the movement of the opposite device to the vicinity of the rendezvous is not finished although the expected time elapses.

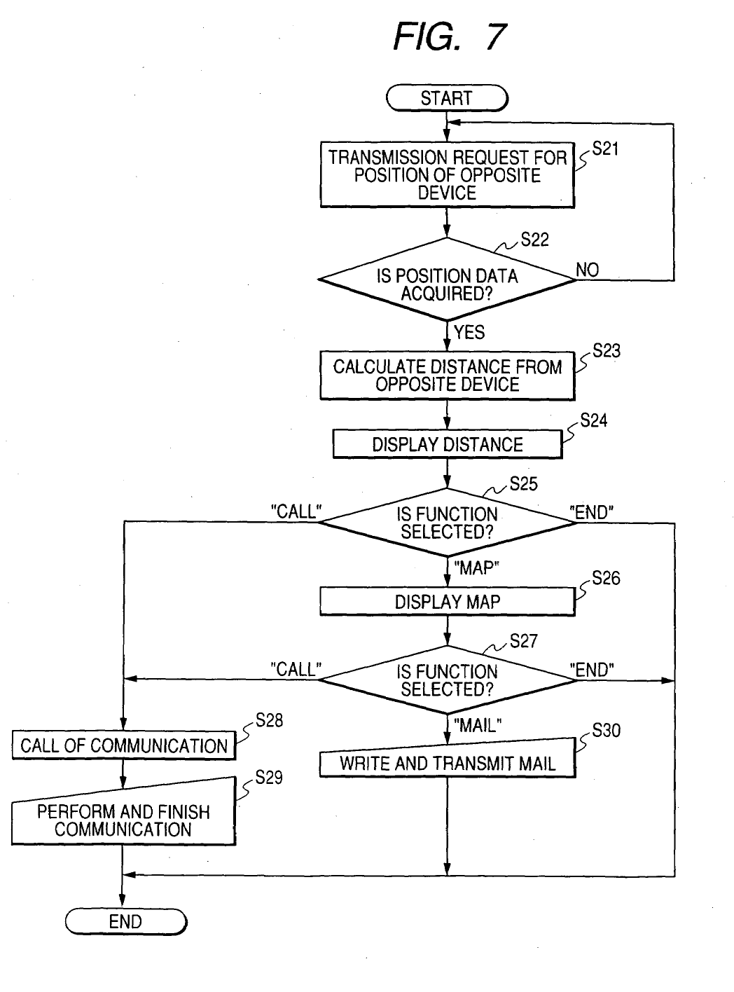

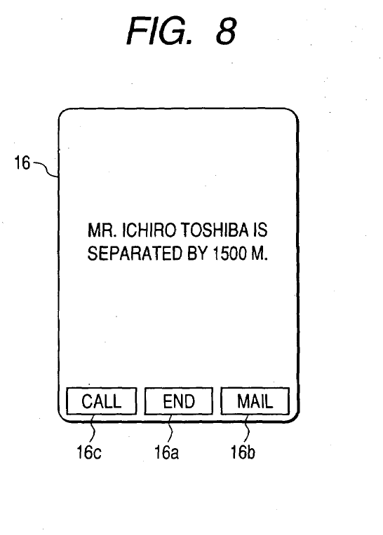

FIG. 7 is a flowchart showing a second modified example of the operation of the communication terminal device 1 according to the first embodiment. After the process starts (“START”), the flow including the steps S21 to S23 is equal to that of the steps S1 to S3 of FIG. 3 and thus their description will be omitted. The control section 15, for example, displays the calculated distance between the communication terminal device 1 and the opposite device obtained in the step S23 on the display section 16, as shown in FIG. 8 (step S24).

Also, the map data may be displayed on the display section 16 (step s9), in case that an operation in step S8 is not performed when a predetermined time has passed after step S7 is executed.

In the vicinity of the central portion of the screen of the display section 16 shown in FIG. 8, the name of the person who possesses the opposite device specified with reference to the telephone directory stored in the memory 19 and the calculated distance are displayed. The function display 16c (“CALL”), the function display 16a (“END”) and the function display 16b (“MAP”) are displayed on the lower side of the screen of the display section 16 shown in FIG. 8. The display contents of the function display 16a and the function display 16b are equal to those of FIG. 4. The display contents of the function display 16c is equal to that of FIG. 5.

When the function key 16a is pressed in the display of FIG. 8 (“END” in the step S25), the control section 15 determines that the distance from the opposite device is confirmed and finishes the process (“END”).

When the function key 16b is pressed in the display of FIG. 8 (“MAP” of the step S25), the control section 15 reads the map data in a range including the positions of the communication terminal device 1 and the opposite device from the memory 19 and displays the map data, for example, on the display section 16, as shown in FIG. 5 (step S26). The flow (steps S27 to S30) until the process is finished after the step S26 is equal to the flow (S10, S5, S6 and S11) until the process is finished after the step S10 of FIG. 3 or 6 and thus their description will be omitted.

When the function key 16 is pressed in the display of FIG. 8 (“CALL” in the step S25), the control section 15 reads the telephone number of the opposite device from the memory 19 and instructs the transmission section 13 and the reception section 14 to originate the call of the communication including the speech with the opposite device (step S28). Subsequently, the communication using the mouthpiece 21 and the earpiece 22 is performed and finished (step S29) and the control section 15 finishes the process (“END”). According to the second modified example, since the branching of the flow after the calculated distance is displayed can be selected, it is determined whether the communication is required or not case by case.

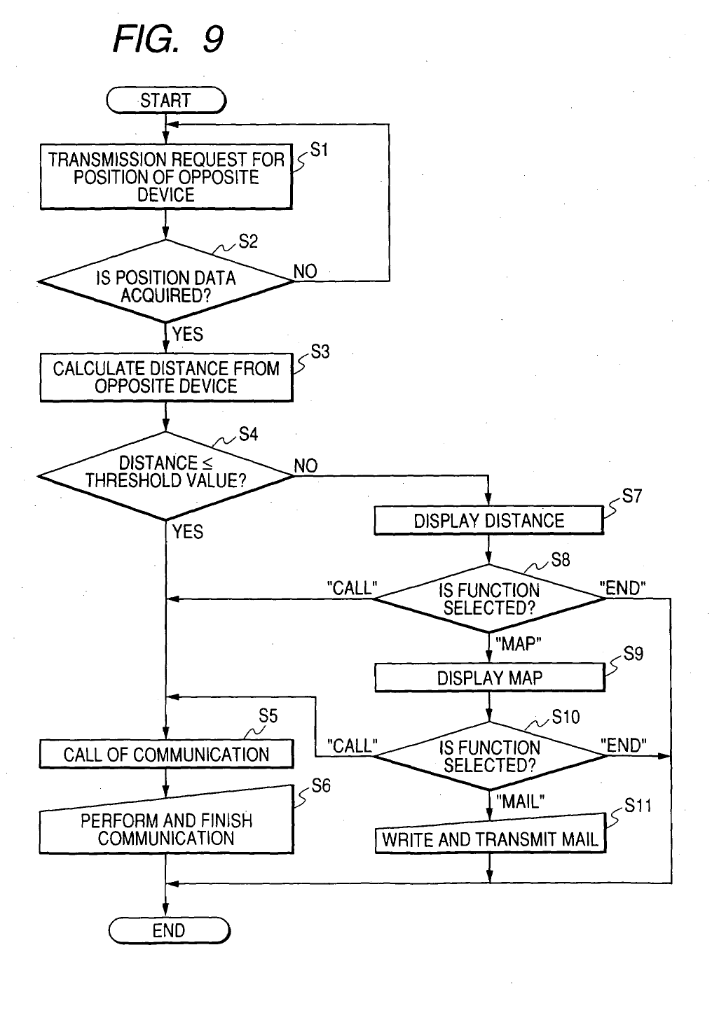

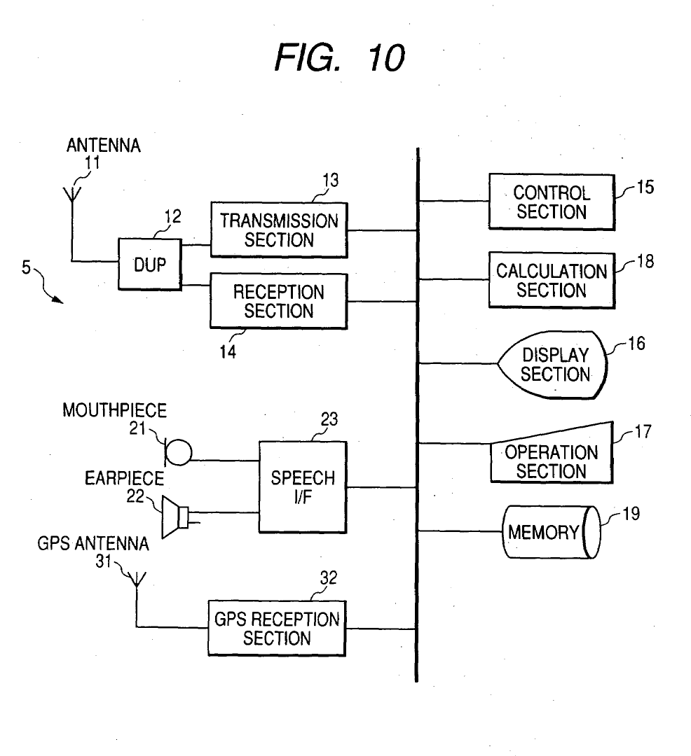

FIG. 9 is a flowchart showing a third modified example of the operation of the communication terminal device 1 according to the first embodiment. Since the flow of FIG. 9 is equal to that of FIG. 3 except one point, these steps are denoted by the same reference numerals as FIG. 3. While the calculated distance is displayed in the step S7 of FIG. 3 as shown in FIG. 4, the calculated distance is displayed in the step S7 of FIG. 9 as shown in FIG. 8.

Also, the map data may be displayed on the display section 16 (step s9), in case that an operation in step S8 is not performed when a predetermined time has passed after step S7 is executed.

When the function key 16c is pressed in the display of FIG. 8 (“CALL” of the step S8), the control section 15 reads the telephone number of the opposite device from the memory 19 and instructs the transmission section 13 and the reception section 14 to originate the call of the communication including the speech with the opposite device (step S5). The other flow is described with reference to FIG. 3 and thus their description will be omitted. The step S4 of FIG. 9 may be replaced with the step S4a of FIG. 6. According to the third modified example, the call can be originated even after displaying the distance, in addition to the call after comparing the distances, and, as a result, the number of the branches can increase.

The communication terminal device 1 need not be the wireless communication device and the first embodiment is applicable to a wired communication terminal device without the antenna 11 and so on. According to the first embodiment, since the call of the communication including the speech with the opposite device is controlled based on the comparison between the distance between the communication terminal device and the opposite device and the predetermined threshold value, it is possible to improve the convenience of a stage such as the rendezvous or the road guidance.

### Second Embodiment

Hereinafter, a second embodiment of the present invention will be described with reference to FIG. 10. FIG. 10 is a block diagram of a communication terminal device 5 according to the second embodiment. The communication terminal device 5 is, for example, a mobile telephone, and may be a personal information assistant (PDA), a personal computer (PC) or the like.

The communication terminal device 5 includes a GPS antenna 3 and a GPS reception section 32. Since the other configurations are equal to those of the communication terminal device 1 shown in FIG. 1, the other configurations are denoted by the same reference numerals as FIG. 1, respectively, and thus their description will be omitted. The GPS reception section 32 receives a wireless frequency signal from a GPS satellite which arrives at the GPS antenna 31 and calculates the position of the communication terminal device 5. The data representing the calculated position of the communication terminal device 5 is stored in the memory 19.

The operation of the communication terminal device 5 is equal to that of the communication terminal device 1 according to the first embodiment except that the data representing the position of the communication terminal device 5 stored in the memory 19 is calculated by the GPS reception section 32. Accordingly, the contents described with reference to FIGS. 2 to 9 in the first embodiment can apply to the communication terminal device 5.

The GPS antenna 31 and the GPS reception section 32 may be replaced with the other positioning means (for example, an acceleration sensor). The communication terminal device S need not be the wireless communication device and the second embodiment may apply to a wired communication terminal device without the antenna 11 and so on. According to the second embodiment, the communication terminal device can freely acquire data representing its position and evaluate the distance from the opposite device. The configurations of the communication terminal device, the flows of the processes and the screen displays are exemplary in the first embodiment and the second embodiment and may be modified without departing from the scope of the present invention.

According to the embodiments, since a communication terminal device determines necessity of communication in accordance with a distance from an opposite party, it is possible to improve convenience in a stage such as rendezvous or road guidance.

What is claimed is:

1. A communication terminal device comprising:
a communication unit configured to communicate with a mobile communication terminal device through a network;
a memory configured to store a first data representing a position of the communication terminal device;
a distance calculation unit configured to calculate a distance from the mobile communication terminal device from a second data representing a position of the mobile communication terminal device received by the communication unit and the first data;
a display unit configured to display the calculated distance; and
a control unit configured to control the communication unit based on the calculated distance and a predetermined threshold value.

2. The communication terminal device according to claim 1, wherein the control unit controls the communication unit when the calculated distance is equal to or smaller than the threshold value.

3. The communication terminal device according to claim 1, wherein the control unit controls the communication unit, when the calculated distance is larger than the threshold value.

4. The communication terminal device according to claim 1, further comprising:
an operation unit configured to input an operation for a call, wherein the control unit allows the display unit to display that the operation for the call can be performed by the operation unit after the calculated distance is displayed on the display unit.

5. The communication terminal device according to claim 1, further comprising:
a positioning unit configured to measure the position of the communication terminal device and acquiring a data representing the position of the communication terminal device.

6. A communication terminal device comprising:
a communication unit configured to communicate with a mobile communication terminal device through a network;
a memory configured to store a first data representing a position of the communication terminal device;
a distance calculation unit configured to calculate a distance from the mobile communication terminal device from a second data representing a position of the mobile communication terminal device received by the communication unit and the first data;
a display unit configured to display the calculated distance; and
a control unit configured to control the display unit based on the calculated distance and a predetermined threshold value.

7. The communication terminal device according to claim 6, wherein the control unit allows the display unit to display an information with respect to the distance when the calculated distance is equal to or smaller than the threshold value.

8. The communication terminal device according to claim 6, wherein the control unit allows the display unit to an information with respect to the distance, when the calculated distance is larger than the threshold value.

9. A communication terminal device comprising:
a communication unit configured to communicate with a mobile communication terminal device through a network;
a memory configured to store a first data representing a position of the communication terminal device;
a distance calculation unit configured to calculate a distance from the mobile communication terminal device from a second data representing a position of the mobile communication terminal device received by the communication unit and the first data;
a display unit; and
a control unit configured to control to allow the display unit to display a data of map including the position of the mobile communication terminal device, based on the calculated distance and a predetermined threshold value.
